(19) United States
(12) Patent Application Publication
(10) Pub. No.: US 2014/0165404 A1
(43) Pub. Date: Jun. 19, 2014

(54) ROLLER CHANGING APPARATUS FOR FURNACES

(71) Applicants: Robert Ebner, Leonding (AT); Andreas Sauschlager, Leonding (AT)

(72) Inventors: Robert Ebner, Leonding (AT); Andreas Sauschlager, Leonding (AT)

(21) Appl. No.: 14/234,557

(22) PCT Filed: Jul. 25, 2012
(86) PCT No.: PCT/EP2012/064620

§ 371 Date: Jan. 23, 2014

(30) Foreign Application Priority Data
Jul. 25, 2011 (DE) 10 2011 079 771.8

(51) Int. Cl. F27B 9/24

(52) U.S. Cl. CPC F27B 9/24
USPC 29/895.1; 29/724

(57) ABSTRACT

Embodiments of the invention relates to a roller changing apparatus for changing a roller from a multiplicity of rollers in a furnace for the thermal treatment of components, wherein the roller changing apparatus has a housing which can be closed off and in which a first protective gas atmosphere can be formed, and a roller handling device which is arranged at least partially in the housing, and which is designed to remove the roller to be exchanged from the furnace and to fit a replacement roller in the furnace while maintaining a high temperature and a second protective gas atmosphere in the furnace during the roller change.

### CROSS-REFERENCE TO A RELATED APPLICATION(S)

This application is a National Phase patent application and claims priority to and benefit of International Application Number PCT/EP2012/064620, filed on Jul. 25, 2012, which claims priority to and benefit of German Patent Application No. 10 2011 079 771.8, filed 25 Jul. 2011, the entire disclosures of which are hereby incorporated herein by reference.

### FIELD OF THE INVENTION

Embodiments of the invention relates to a roller changing apparatus and a method for changing a roller of a furnace for the thermal treatment of components and relates to an arrangement consisting of a roller changing apparatus and a furnace.

### TECHNOLOGICAL BACKGROUND

A roller hearth furnace serves for heating up and/or temperature-balancing continuously cast products or other components that consist, in particular, of steel or steel raw materials or of other materials such as copper or aluminum and that are transported through the furnace chamber on rollers. Such roller hearth furnaces are very long and their interior is filled with gas of a very high temperature. In terms of size, for example, one hundred to two hundred rollers may be arranged along a roller hearth furnace that has a length of for example one hundred meters and that may be brought to a temperature of for example 1000° C. For example, a protective gas atmosphere of hydrogen (or a hydrogen-nitrogen mixture) may be formed in the interior of the furnace.

If an individual roller of the multitude of rollers is defective, it is traditionally required to switch off the entire furnace, to flush the furnace with nitrogen, to cool down the furnace, to exchange the roller, and to fill the furnace again with hydrogen before the furnace is restarted. Such a procedure may require, for example, one to three days and is very elaborate.

### SUMMARY OF THE INVENTION

It may be an object of the present invention to realize an exchange of rollers of a furnace for the thermal treatment of components in an efficient fashion.

This object is solved by means of the subject matters with the features of the independent claims. Other exemplary embodiments are disclosed in the dependent claims.

According to one exemplary embodiment of the present invention, a roller changing apparatus for changing one roller of a multitude of rollers of a furnace for the thermal treatment of components is provided. The roller changing apparatus has a housing that can be sealed (i.e. sealed relative to the surroundings) and in which a first protective gas atmosphere can be formed. The roller changing apparatus furthermore has a roller handling device that is at least partially arranged in the housing (but may also be movable out of the housing and, for example, into the furnace). The roller handling device is designed for removing the roller to be exchanged from the furnace and for installing a replacement roller in the furnace while maintaining a high temperature and a second protective gas atmosphere in the furnace during the roller exchange.

According to another exemplary embodiment of the invention, an arrangement is made available that comprises a roller changing apparatus with the above-described features and the furnace for the thermal treatment of components.

According to yet another exemplary embodiment of the invention, a method for changing one roller of a multitude of rollers of a furnace for the thermal treatment of components is provided. In this method, a first protective gas atmosphere is formed in a housing of the roller changing apparatus that can be sealed, the roller to be exchanged is removed from the furnace with a roller handling device of the roller changing apparatus that is at least partially arranged in the housing, and a replacement roller is installed in the furnace with the roller handling device. A high temperature and a second protective gas atmosphere are maintained in the furnace during the removal and during the installation.

The term protective gas atmosphere in the furnace chamber refers to a gas atmosphere that is suitable for the thermal treatment of components in the form of products to be annealed at a correspondingly high temperature. A corresponding protective gas should have an adequate thermal conductivity, such as for example, hydrogen or helium, in order to efficiently heat the products to be annealed.

The term high temperature in the furnace chamber refers to a temperature that respectively is significantly increased in comparison with an ambient temperature of the furnace or in comparison with a normal temperature and may be as high as the range of an operating temperature of the furnace during the thermal treatment of products to be annealed. For example, the high temperature that is maintained or at least could be maintained during a roller exchange due to the design of the roller changing apparatus may lie in the range between 500° C. and 1200° C., i.e. in the range of an operating temperature of the furnace.

The term “while maintaining a high temperature and a second protective gas atmosphere in the furnace during the roller exchange” refers to the roller exchange neither requiring a previous flushing of the furnace chamber or a complete evacuation of the second protective gas atmosphere nor the complete cooling of the furnace from an operating temperature for the thermal treatment of products to be annealed to the ambient temperature. According to embodiments of the invention, however, a certain mixing of the first protective gas atmosphere with the second protective gas atmosphere may by all means take place if a fluid-tight connection is created between the interiors of the furnace and the housing during the roller exchange. According to embodiments of the invention, slight cooling of the interior of the furnace likewise may by all means take place during the roller exchange, for example, because a heating device is switched off or a certain cooling process is carried out. It is rather important that the traditionally required complex logistics (with an expenditure of time, for example, of two days) for completely cooling the furnace and for completely flushing out the H2 protective gas (or a hydrogen-nitrogen mixture) are in accordance with embodiments of the invention at least partially eliminated. According to embodiments of the invention, it is furthermore possible to forgo a removal of the components, i.e. the products to be annealed, from the furnace for the duration of the roller exchange.

Embodiments of the invention therefore makes available a roller changing apparatus with a housing that can be sealed in a gas-tight fashion and is filled with a protective gas that can be chosen such that it is respectively harmless or safe for a furnace such as, for example, nitrogen. In order to carry out the roller exchange, the roller changing apparatus can be connected to the furnace at the position of the roller to be exchanged. An exchange of the roller can take place through an opening in the housing. This procedure makes it possible to maintain the protective gas atmosphere in the furnace, as well as the temperature in the furnace, because the furnace interior is only fluidically connected to the protective gas atmosphere of the housing that can be sealed, as well as decoupled from the surroundings with a damaging oxygen-containing atmosphere in a gas-tight fashion during the entire roller exchange. According to embodiments of the invention, the furnace interior therefore is prevented from coming in contact with oxygen and creating a potential fire hazard. Due to these measures it is possible to carry out the exchange of rollers within a significantly shorter time, for example, of one hour. This can be realized by means of a mechanism that allows the removal of a defective roller and the installation of a new roller while maintaining the protective gas and the temperature in the furnace interior.

Other exemplary embodiments of the roller changing apparatus are described below. These embodiments also apply to the arrangement and the method.

According to an exemplary embodiment, the roller changing apparatus may comprise a movable platform that is designed for moving the roller handling device together with the housing relative to the furnace in order to position the roller handling device relative to the roller to be exchanged. Such a movable platform makes it possible to move the roller handling device to an arbitrary number of the multitude of rollers of the furnace and to position the roller handling device accordingly.

According to an embodiment, the roller handling device can be at least partially moved out from the housing through a lock in a wall of the housing in order to handle the roller to be exchanged. Such a lock in the housing wall that can be sealed and selectively opened makes it possible to carry out installation and removal procedures on individual rollers of the furnace from the interior of the housing.

According to an exemplary embodiment, the lock on the wall of the housing may comprise an attachment fitting at the outside of the housing that is designed for being mounted at the furnace in such a way that a tight connection, particularly a gas-tight connection relative to the surroundings, can be produced between an interior of the housing and an interior of the furnace. The attachment fitting may respectively enclose or accommodate in its interior a cap of the roller to be exchanged at the outside of the furnace if this cap is removed prior to the removal of the actual roller body. The attachment fitting may be realized such that it can be flanged to the furnace, particularly screwed thereto. This attachment fitting advantageously can be mounted in a gas-tight fashion on a corresponding counterpart of the furnace (for example a corresponding counter flange in the region of the roller to be exchanged) in order to subsequently make it possible to work in particular on this roller without respectively risking a loss of the prospective gas atmosphere in the interior of the furnace or an admission of oxygen.

According to an exemplary embodiment, the roller handling device may be movable in a translative fashion along one, two or three dimensions or directions in space, respectively. The roller handling device may alternatively or additionally be pivotable about one or more axes. For example, the roller handling device may comprise a lance that can be arbitrarily aligned relative to a roller, namely with respect to translative and rotatory degrees of freedom. In this way, a precise mechanical coupling to the roller to be exchanged can be realized.

According to an exemplary embodiment, the roller handling device may be designed for exerting a closing pressure that seals the furnace upon the cap while at least one fastening element (for example screws) is removed from a cap of the roller to be exchanged in a manual or machine-controlled fashion in order to separate the cap from the furnace. When fastening screws or the like are removed from a cap such that the seal is broken, the closing pressure of the roller handling device acting upon the cap makes it possible to maintain a gas-tight connection in the interior of the furnace despite the lack of fastening elements, wherein this is of the utmost importance for preventing the admission of undesirable gases into the furnace chamber.

According to an exemplary embodiment, the roller handling device may be designed for removing a cap of the roller to be exchanged from the furnace, in particular by means of a catch. The roller handling device may furthermore be designed for transporting the removed cap into the interior of the housing and for storing the cap therein. The roller handling device may be designed, in particular, for removing the cap of the roller to be exchanged from the furnace and for transporting the cap into the housing through the attachment fitting mounted at the furnace. In other words, the closing pressure of the roller handling device can initially be maintained prior to the removal of the cap and the attachment fitting can be flanged to the furnace in a gas-tight fashion at the corresponding location. In this way, the gas-tightness between the furnace and the housing is continuously ensured. The cap can now be removed, transported into the housing interior and, for example, placed on a shelf therein. All this may respectively take place in a machine-controlled or in a robot-controlled fashion.

According to an exemplary embodiment, the roller handling device may be designed for moving into the roller to be exchanged in the furnace after removing the cap of the roller to be exchanged and for initially raising the roller to be exchanged relative to a movable bearing (provided for geometrically compensating thermal expansion effects) in the furnace. For example, the lance of the roller handling device can move into an internal cavity of the tubular roller while the roller is still connected to the movable bearing, for example, at three support points thereof. In order to remove the movable bearing from the furnace, the movable bearing initially needs to be alleviated from the load of the roller, wherein this may be realized by raising the roller relative to the movable bearing.

According to an exemplary embodiment, the roller handling device may be designed for transporting the movable bearing into the interior of the housing and for depositing the movable bearing therein, in particular by means of a catch, after moving into the roller to be exchanged. Such a catch may be arranged, for example, at a lance of the roller handling device and bring about a transport of the movable bearing into the interior of the housing. Also in this state, the docking fitting of the housing preferably is connected to a counter flange of the furnace in a gas-tight fashion such that also the removal of the movable bearing does not affect the protective gas atmosphere in the interior of the furnace.

According to an exemplary embodiment, the roller changing apparatus may comprise a component support mechanism that, in particular, is at least partially arranged in the interior of the housing and serves for supporting the components (for example a strip to the thermally treated) in the furnace during at least a part of the roller exchange. According to embodiments of the invention, the roller exchange may take place while the component (for example a strip or other products to be annealed) remains at a high temperature, for example, of 1000° C. in the interior of the furnace. When the roller, on which the component lies, should be exchanged, a support of the component should initially be realized prior to exchanging the roller. This task is carried out by the component support mechanism that can be moved from the interior of the housing into the furnace, preferably through the docking fitting of the housing, and in the meantime fulfills the support function of the roller to be exchanged.

According to an exemplary embodiment, the component support mechanism may be realized such that it is movable in a translative fashion and/or pivotable. In this way, the component support mechanism can be selectively transferred into an active state (in which it supports the component) or into a passive state (in which it does not support the component) such that the component support mechanism and the roller handling device do not interfere with one another.

According to an exemplary embodiment, the component support mechanism may comprise a pipe segment that can be moved into the furnace and can be pivoted around the roller to be exchanged in order to thusly support the components. For this purpose, a diameter of the pipe, from which the pipe segment is formed, should be larger than the diameter of the roller such that the pipe segment can pivot around the roller. The component support mechanism should already fulfill the support function of the roller while the roller to be exchanged is still arranged in the interior of the furnace. This is the reason why the component support mechanism can be arranged, for example, concentric or partially concentric around the roller to be exchanged and pivoted around the roller not till being in the interior of the furnace in order to thusly support the component from the underside. This allows a particularly space-saving configuration. For example, the pipe segment may amount to a sixth or a fourth of the pipe, i.e. it may represent a 60°-section or 90°-section of a complete pipe. Once the component support mechanism fulfills the support function, the roller to be exchanged can be removed from the furnace.

According to an exemplary embodiment, the roller handling device may be designed for transporting the roller to be exchanged out of the furnace, as well as for transporting this roller into the interior of the housing and storing the roller therein, after separating the roller to be exchanged from a movable bearing and from a fixed bearing of the furnace. Each roller may be supported on the furnace by means of a fixed bearing at one side and by means of a movable bearing at the other side. With respect to the support of a pin of the roller, the fixed bearing holds the pin in its position while the movable bearing allows a thermal expansion in the longitudinal direction. In furnace rollers, a movable bearing is/can be arranged on the one side and a fixed bearing is/can be arranged on the other side in order to compensate thermal expansions. Prior to the removal of the roller to be exchanged from the furnace, the second bearing that typically consists of a fixed bearing therefore still needs to be separated, for example manually. In this case, it needs to be observed that this part of the furnace remains gas-tight after the separation of the movable bearing from the roller, wherein this can be realized, for example, by utilizing a sealing screw or the like.

According to an exemplary embodiment, the roller handling device may be designed for installing a replacement roller stored in the interior of the housing in the furnace after transporting the roller to be exchanged into the interior of the housing. This procedure is essentially inverse to the above-described removal procedure of the roller to be exchanged. The roller initially needs to be mounted on the fixed bearing. The roller is then mounted on the movable bearing before the cap can be attached to the replaced roller from outside. These steps can be carried out with the same roller handling device, in particular by means of the same lance, as the removal of the roller to be exchanged.

For example, it is possible to store eight to twelve replacement rollers in the housing. Likewise, there is space for accommodating a corresponding number of defective rollers in corresponding shelves or the like. Bearing components and caps of the rollers respectively can also be stored in the interior of the housing in order to also maintain the protective gas atmosphere during the exchange of several rollers.

According to an exemplary embodiment, both the first protective gas atmosphere and the second protective gas atmosphere may essentially be free of oxygen. In particular the first protective gas atmosphere may be an inert gas atmosphere, in particular a nitrogen atmosphere, and the second protective gas atmosphere may be a burnable gas atmosphere, in particular a hydrogen atmosphere. These measures significantly improve the operating safety, for example, because the burnable gas should be prevented from coming in contact in particular with oxygen in the furnace interior.

A heating device for heating the furnace may be, for example, an electric heating unit or a gas heating unit for directly heating the furnace interior, in particular the protective gas contained therein. A heating unit that utilizes electromagnetic radiation as heating medium would also be conceivable. The corresponding heating unit can be selectively switched off or remain switched on during the exchange of a roller.

In the following other exemplary embodiments of the method are described. These embodiments also apply to the roller changing apparatus and the arrangement.

According to an exemplary embodiment, a high temperature, that lies in a range between approximately 500° C. and approximately 1200° C., can be maintained in the furnace during the exchange of the roller. Consequently, a time consuming cooling of the furnace associated with energy losses is prevented because the exchange of the roller effectively can take place at the operating temperature or at least in the still warm or still hot furnace state.

According to an exemplary embodiment, an interior of the furnace may remain sealed relative to the surroundings, in particular remain fluidically connected to only an interior of the roller changing apparatus, and furthermore remain, in particular, free of oxygen during the entire exchange of the roller. Consequently, the furnace remains gas-tight relative to the laboratory environment and is only fluidically connected to the roller changing apparatus. However, since this roller changing apparatus can be equipped with a freely selectable protective gas atmosphere, the protective gas atmosphere can be chosen such that no negative effect for the furnace results.

According to an exemplary embodiment, a drive unit can be detached on the fixed bearing side of the furnace prior to the removal of the roller from the furnace and the roller to be exchanged can be forced off by means of a gas-tight screw. Such a drive unit may be arranged at the outside of the furnace and provided separately for each roller. However, it is also possible to provide a common drive unit for a group of rollers or even for all rollers.

Exemplary embodiments of the present invention are described in greater detail below with reference to the following figures.

### DESCRIPTION OF THE DRAWING

FIG. 1 shows a schematic view of an arrangement comprising a roller changing apparatus and a furnace for a thermal treatment of components according to an exemplary embodiment of the invention.

FIG. 2 shows a three-dimensional view of a roller removing device according to an exemplary embodiment of the invention in combination with a roller furnace.

FIG. 3 shows the arrangement according to FIG. 2 in the form of a different three-dimensional view.

FIG. 4 shows an exploded view of the arrangement according to FIG. 2, in which a few components are omitted and the required positioning of the arrangement relative to a roller of a furnace to be exchanged is illustrated.

FIG. 5 shows the arrangement according to FIG. 2 in an operating state, in which a cap of the roller to be exchanged is pressed on in order to meanwhile remove connecting screws.

FIG. 6 shows the arrangement according to FIG. 2, wherein the housing is screwed to the furnace in a gas-tight fashion and is flushed with nitrogen.

FIG. 7 shows a detailed view of a docking fitting of the housing and a cap of the roller to be exchanged in the arrangement according to FIG. 2.

FIG. 8 shows the arrangement according to FIG. 2 after depositing the cap removed from the roller.

FIG. 9 shows the arrangement according to FIG. 2 while the roller is raised prior to the removal of a movable bearing.

FIG. 10 shows the design of the movable bearing in the arrangement according to FIG. 2.

FIG. 11 shows how a shell for supporting a strip support is inserted into the furnace from the housing.

FIG. 12 shows the arrangement according to FIG. 2 in a state, in which the shell is already located in the interior of the furnace.

FIG. 13 shows an outer wall of the furnace on the fixed bearing side and a driveshaft for driving the roller mounted thereon prior to the removal of the driveshaft.

FIG. 14 shows a side view of the roller to be removed that can be forced off by means of a gas-tight screw from the fixed bearing side.

FIG. 15 shows the arrangement according to FIG. 2 while the roller is picked up.

FIG. 16 shows the arrangement according to FIG. 2 after depositing the roller removed from the furnace in the housing.

FIG. 17 shows how the removed roller is deposited at a shelf.

FIG. 18 shows the arrangement according to FIG. 2 during the installation of a replacement roller.

FIG. 19 shows the arrangement according to FIG. 2 during the pivoting of a strip support.

FIG. 20 shows the arrangement according to FIG. 2 during the extension of the strip support.

FIG. 21 shows the arrangement according to FIG. 2 during the reinstallation of the movable bearing.

FIG. 22 shows the arrangement according to FIG. 2 prior to the retrieval of the cap for its reinstallation on the furnace.

FIG. 23 shows how the cap is positioned and pressed on.

FIG. 24 shows how the attachment fitting of the housing is detached from the furnace and how the cap is screwed on.

FIG. 25 shows a detailed view of the fixed bearing of the arrangement according to FIG. 2.

### DETAILED DESCRIPTION OF EXEMPLARY EMBODIMENTS

Identical or similar components are identified by the same reference symbols in different figures.

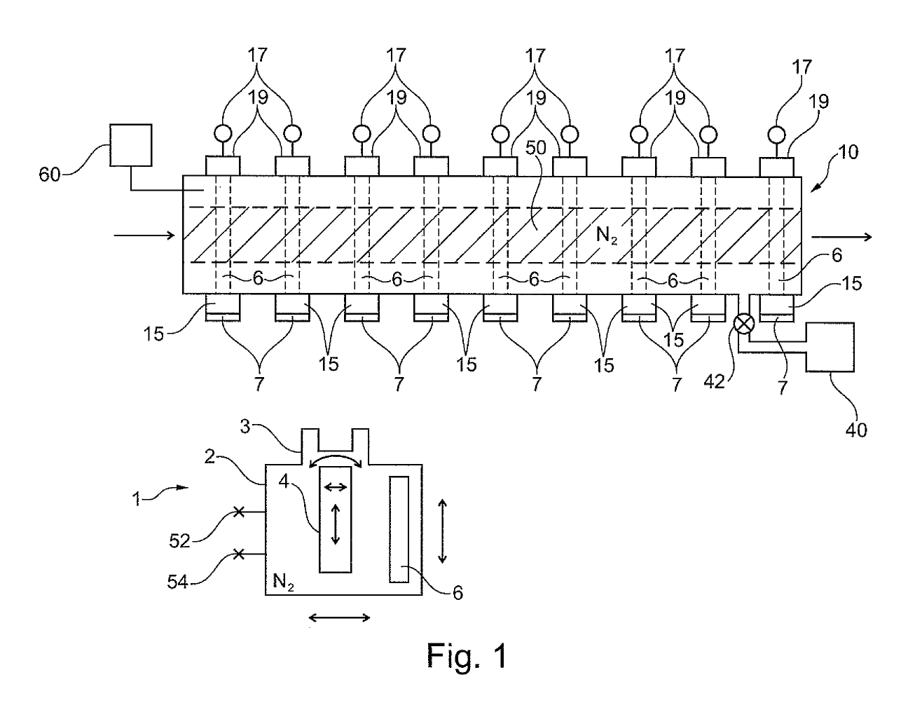

FIG. 1 shows a top view of an arrangement according to an exemplary embodiment of the invention that is composed of a roller changing apparatus 1 and a furnace 10 for the thermal treatment of strips 50 of metal.

The furnace 10 is a roller hearth furnace, in which a strip 50 of metal or other components to be subjected to a thermal treatment are transported through the furnace 10 that is hermetically sealed relative to the surroundings and thereby heated in a continuous process (see arrows in FIG. 1). The strip 50 may be, for example, unwound from a (not-shown) coiler prior to entering the furnace 10 and once again wound up on another (not-shown) coiler after exiting the furnace 10. Along its longitudinal axis, the furnace 10 comprises a multitude of rollers 6 for transporting the metal strip 50. The length of the furnace 10 from the left end to the right end may amount, for example, to 20 m, 50 m or 100 m. While the strip 50 is situated in the furnace 10, it is maintained at a high temperature, for example, of 1000° C. This is realized by means of a schematically illustrated heating unit 60 that heats the furnace interior. The heating unit 60 may be, for example, an electric heating unit or a gas heating unit. A protective gas atmosphere of hydrogen is present in the interior of the furnace 10. Hydrogen is a gas with adequate thermal conductivity and can efficiently transfer heat from the heating unit 60 to the strip 50. The hydrogen can be introduced into the interior of the furnace 10 through a valve 42 by means of a protective gas atmosphere control unit 40. If so required, the protective gas atmosphere control unit 40 can flush the hydrogen from the interior of the furnace 10 and replace the hydrogen, for example, with another flushing gas.

Each of the rollers 6 of the furnace 10 is rotatably supported at a respective wall of the furnace 10 by means of a fixed bearing 19 at one end and by means of a movable bearing 15 at the other end. A cap 7 seals the respective roller 6 in a gas-tight fashion on the side of the movable bearing 15. The fixed bearing 19 is also realized in a gas-tight fashion such that no hydrogen can escape from the interior of the furnace 10 and no oxygen can be admitted into the furnace 10 from the surrounding atmosphere during the operation of the furnace 10. In the exemplary embodiment shown, each of the rollers 6 comprises a separate drive unit 17 that rotatably drives the respective roller 6 in order to thusly transport the strip 50. In a (not-shown) alternative embodiment, several or all rollers 6 may alternatively be driven by means of a common drive unit.

According to embodiments of the invention, the furnace 10 is operated together with the roller changing apparatus 1 that serves for exchanging individual rollers 6 of the furnace 10, for example, when they are defective or require maintenance. According to embodiments of the invention, such an exchange can be carried out without having to significantly reduce the temperature in the interior of the furnace 10 or without having to flush out and replace the protective gas atmosphere of hydrogen in the interior of the furnace 10 with another protective gas. This represents a significant saving in time in comparison with conventional systems, in which exactly these procedures are required.

In order to realize an efficient roller exchange, the roller changing apparatus 1 comprises a housing 2 that can be sealed and in which a protective gas atmosphere, for example, of nitrogen can be formed. The housing 2 can be hermetically sealed, however it can still be controlled from the surroundings. FIG. 1 shows that the housing 2 comprises a protective gas control interface 52 for supplying and discharging protective gas. The housing 2 furthermore has an electric interface 54 for supplying and delivering electrical signals (for example for control or monitoring purposes) and for supplying the roll changing apparatus 1 with electric energy. The interfaces 52, 54 are configured in such a way that the interior of the housing 2 is isolated from the surroundings in a gas-tight fashion, i.e. that the protective gas atmosphere of nitrogen is maintained in the interior of the housing 2.

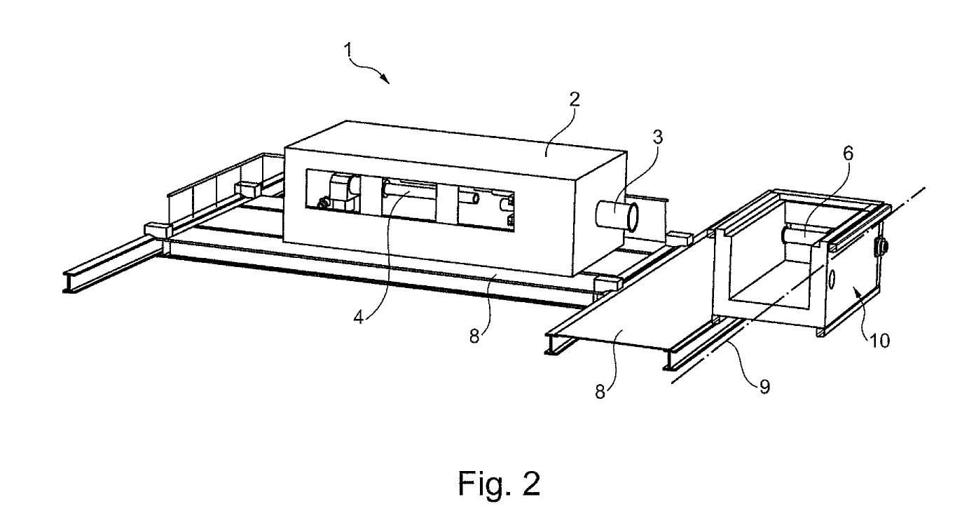

Furthermore, a roller handling device 4 is arranged in the interior of the housing 2 such that it is movable in a translative fashion and pivotable as indicated with arrows in FIG. 1. Such a roller handling device 4 makes it possible to remove a certain roller of the rollers 6 of the furnace 10 and to accommodate said roller in the interior of the housing 2 as described in greater detail below with reference to FIG. 2 to FIG. 25. The roller handling device 4 is furthermore capable of installing a replacement roller 6 that is stored in the interior of the housing 2 while continuously maintaining the high temperature in the furnace 10 and while continuously maintaining the oxygen-free protective gas atmosphere in the furnace 10. Nevertheless, certain amounts of the nitrogen that is harmless for the operation of the furnace 10 may be admitted into the interior of the furnace 10 from the interior of the housing 2 during the roller exchange. However, the extreme admission of oxygen into the furnace interior is reliably prevented during the entire roller exchange because the entire exchange of the roller 6 to be exchanged takes place while a gas-tight connection between the furnace 10 and the housing 2 is produced.

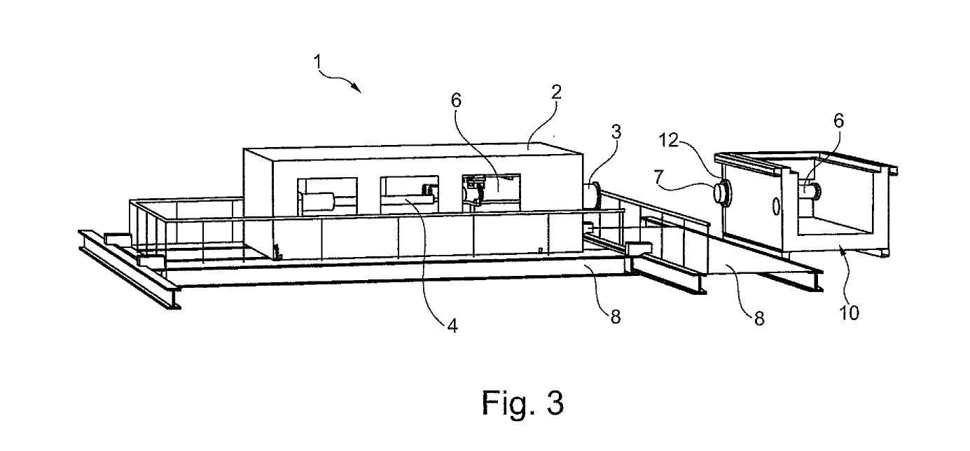

The operation of the inventive arrangement illustrated in FIG. 2 to FIG. 25 is initially described generally and then in greater detail. FIG. 2 and FIG. 3 show two three-dimensional views of the arrangement.

The roller changing apparatus 1 illustrated in these figures is enclosed by a cuboid, gas-tight housing 2 with various fluid connections and electrical connections, as well as a docking fitting 3 including a flange. Among other things, the following components are situated within the housing 2:

a longitudinally, laterally and vertically movable lance 4 with a tilting function for flexure compensation

a longitudinally movable and pivotable strip support mechanism 26

shelves 5 for depositing rollers 6 and furnace caps 7

different monitoring and control devices.

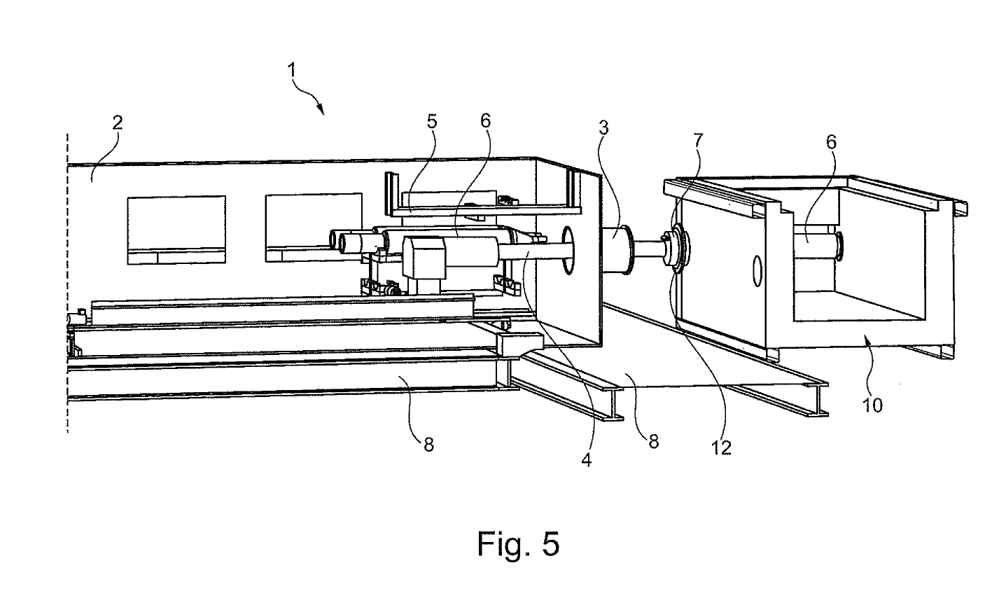

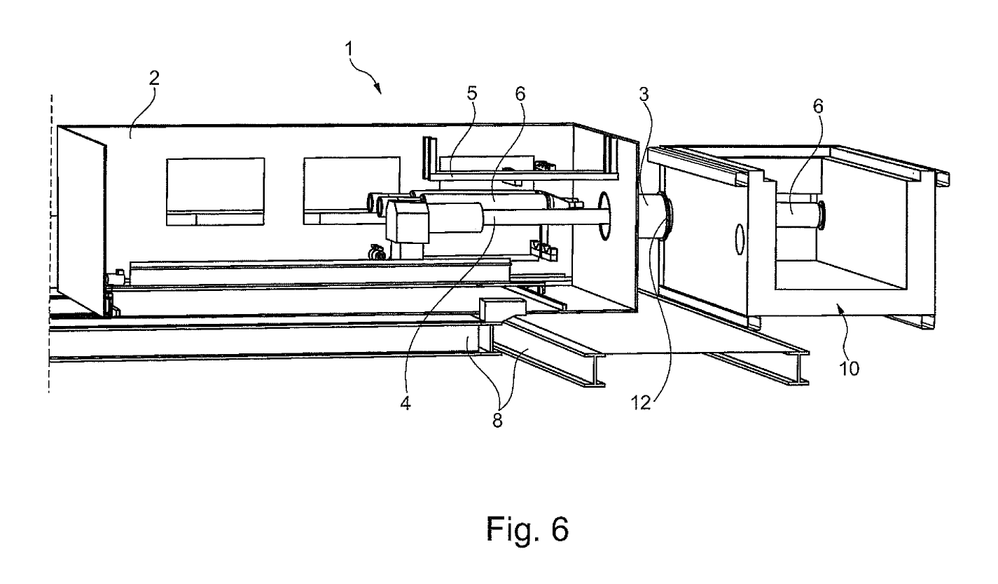

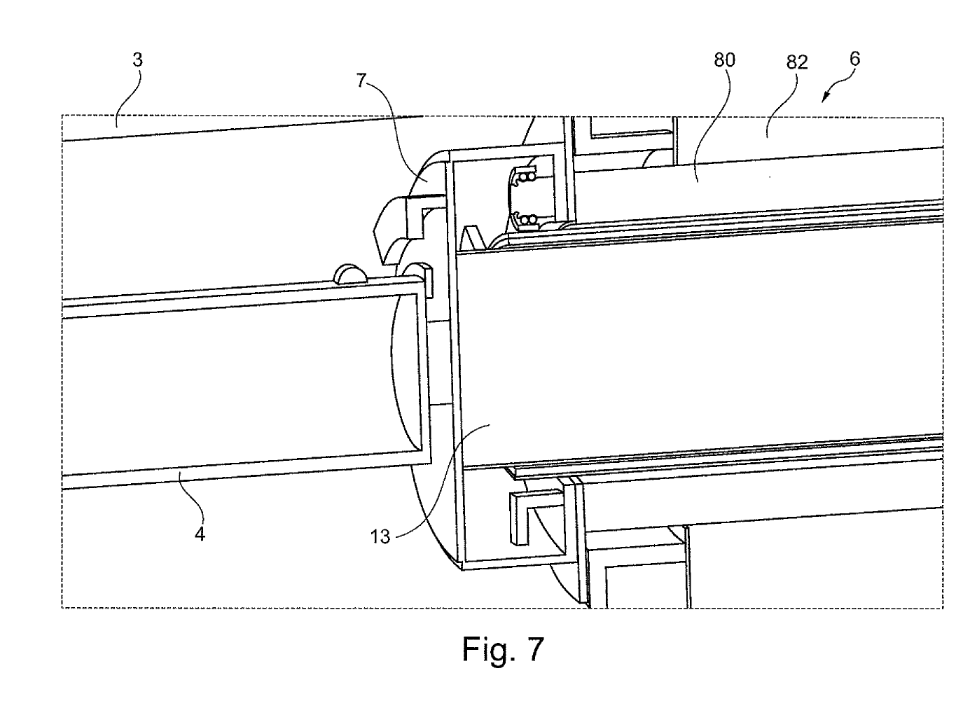

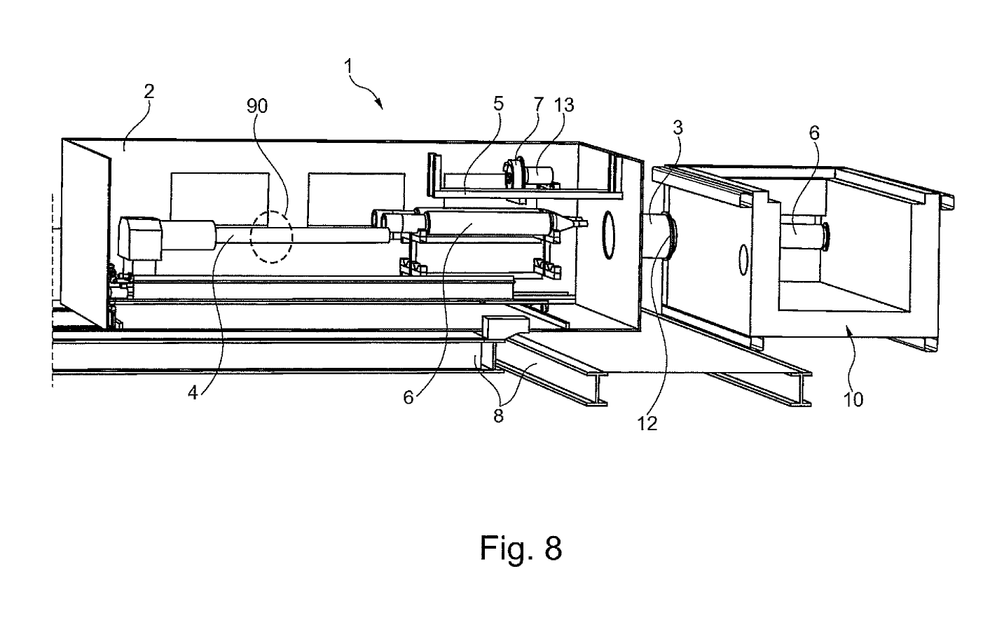

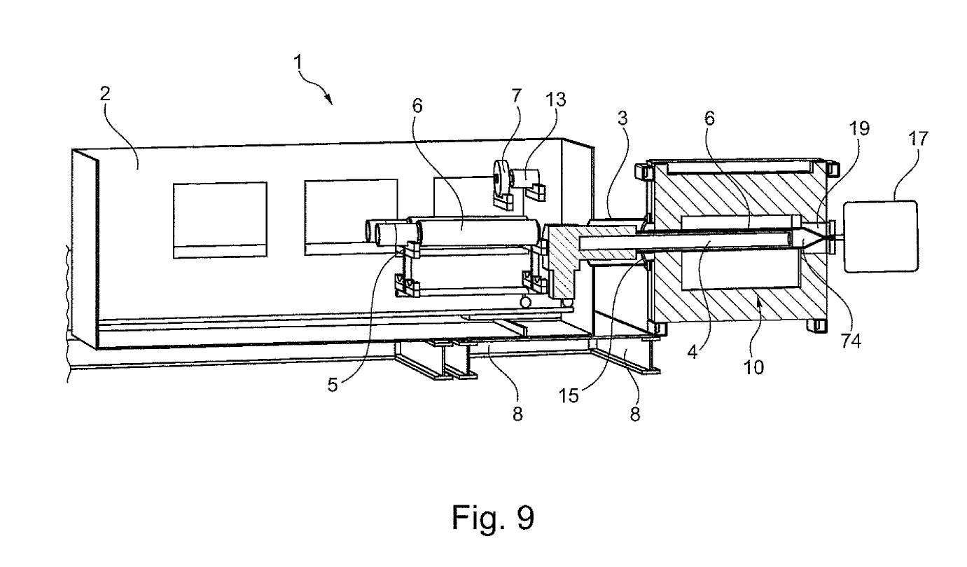

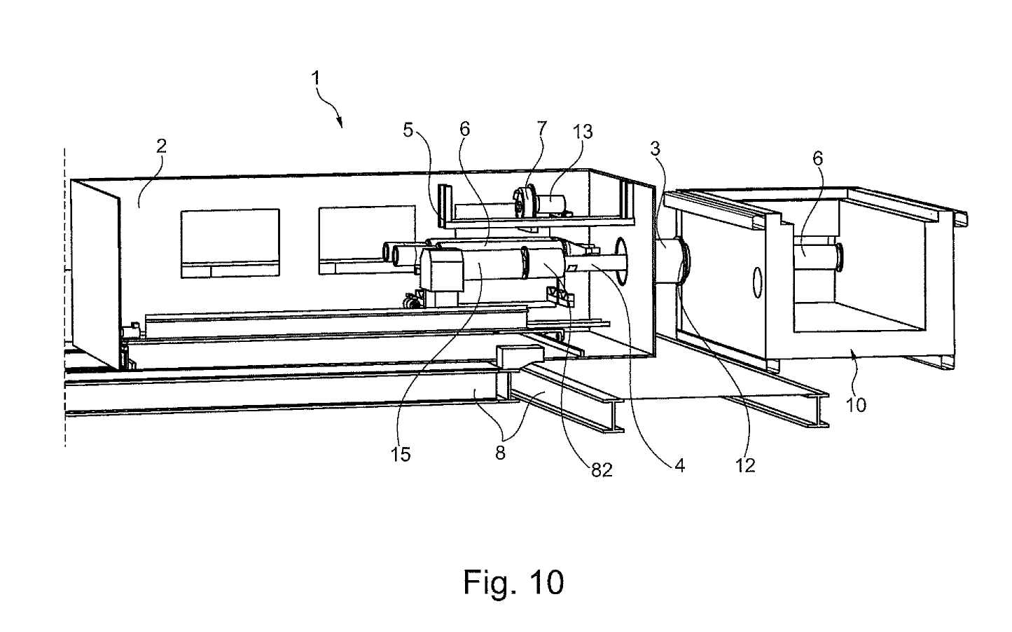

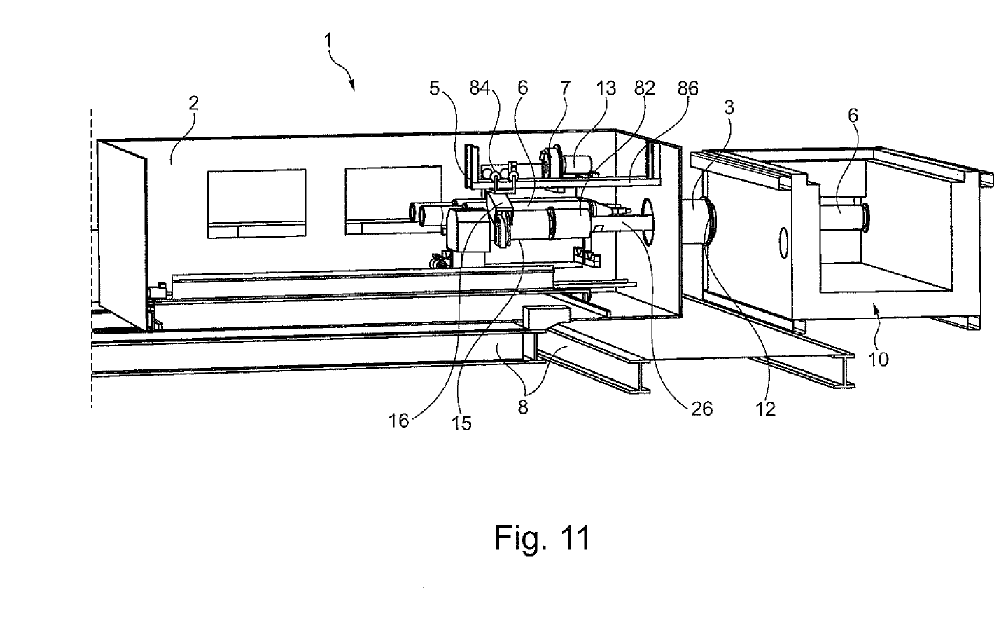

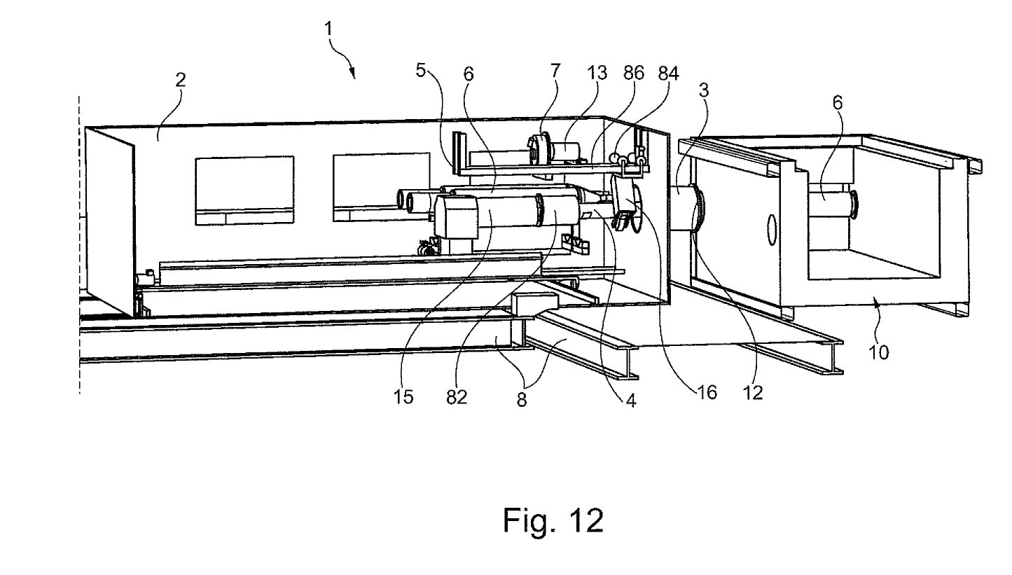

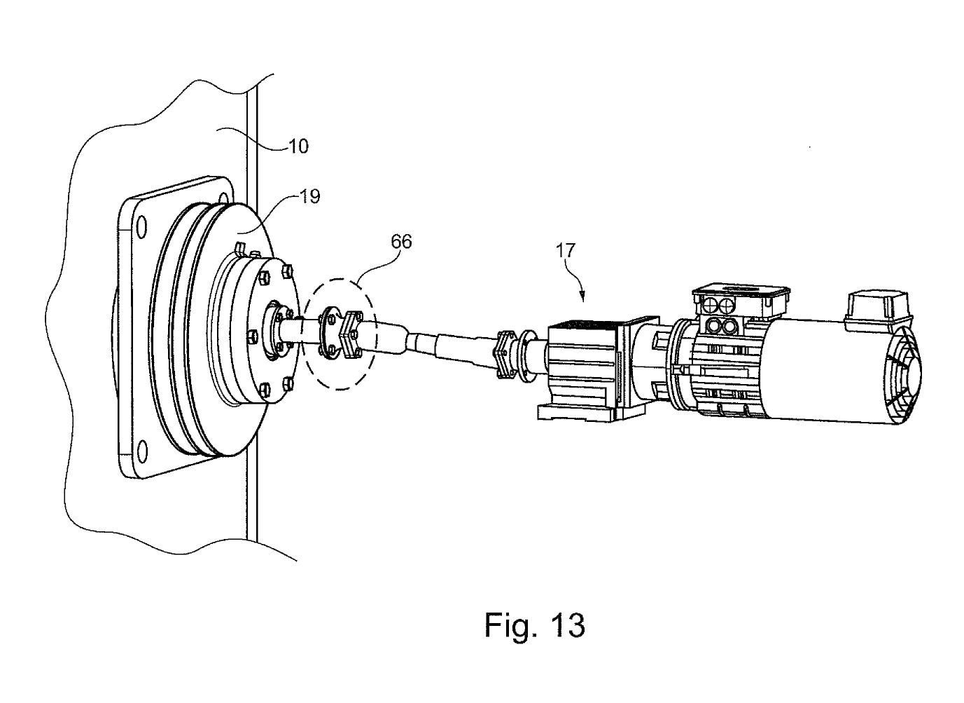

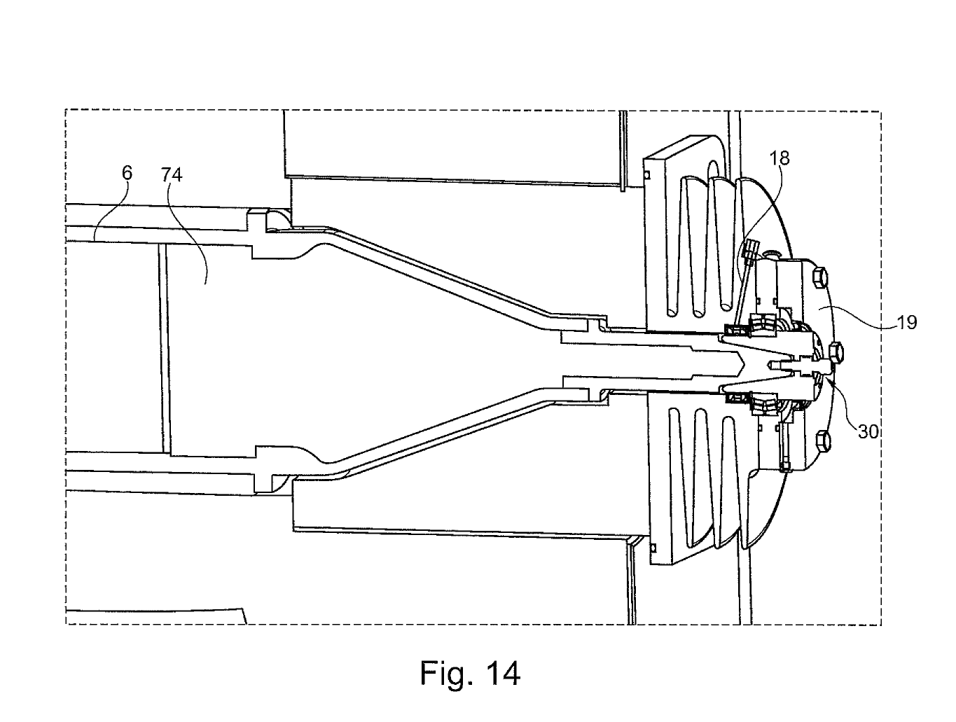

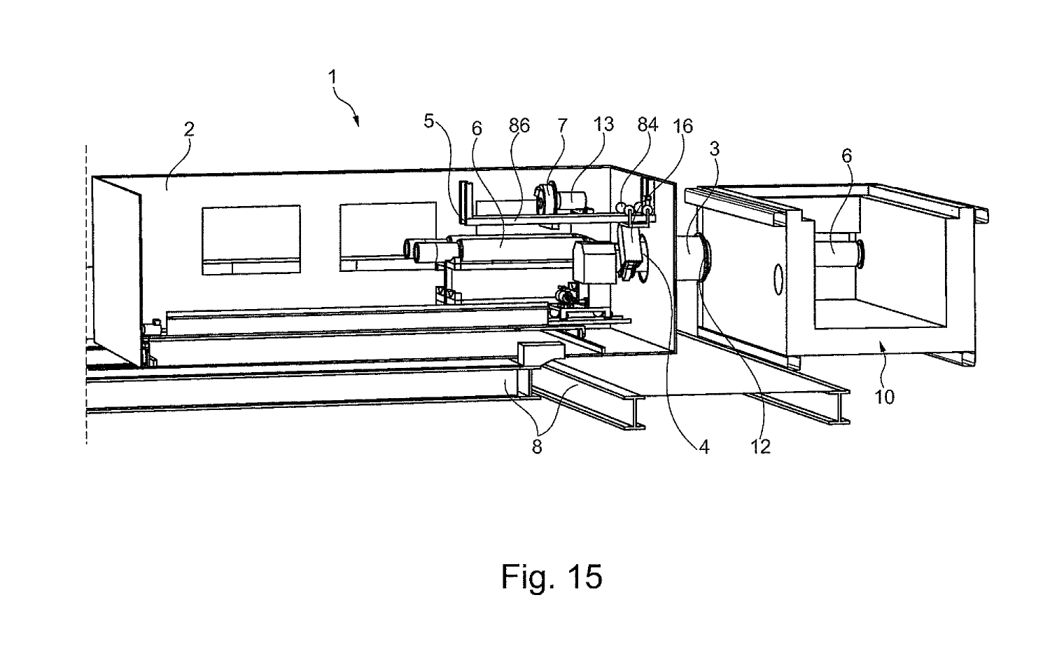

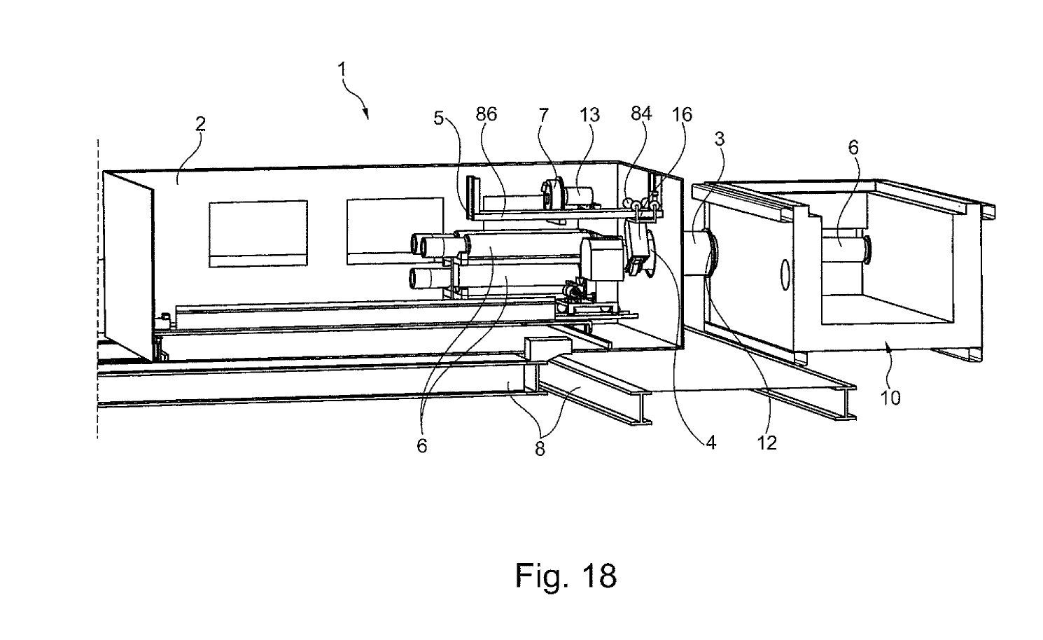

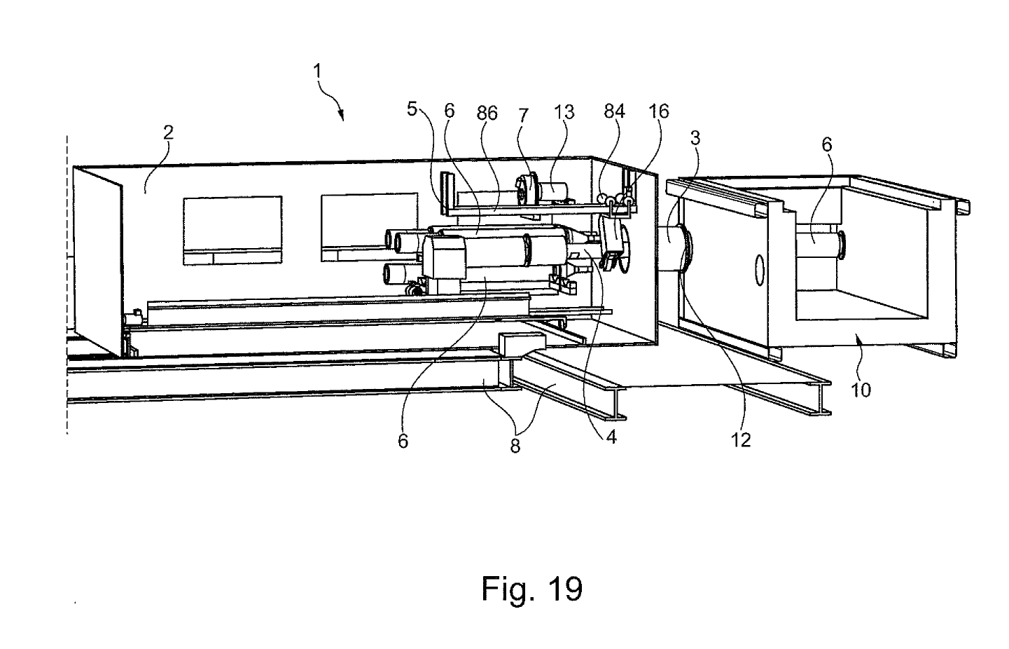

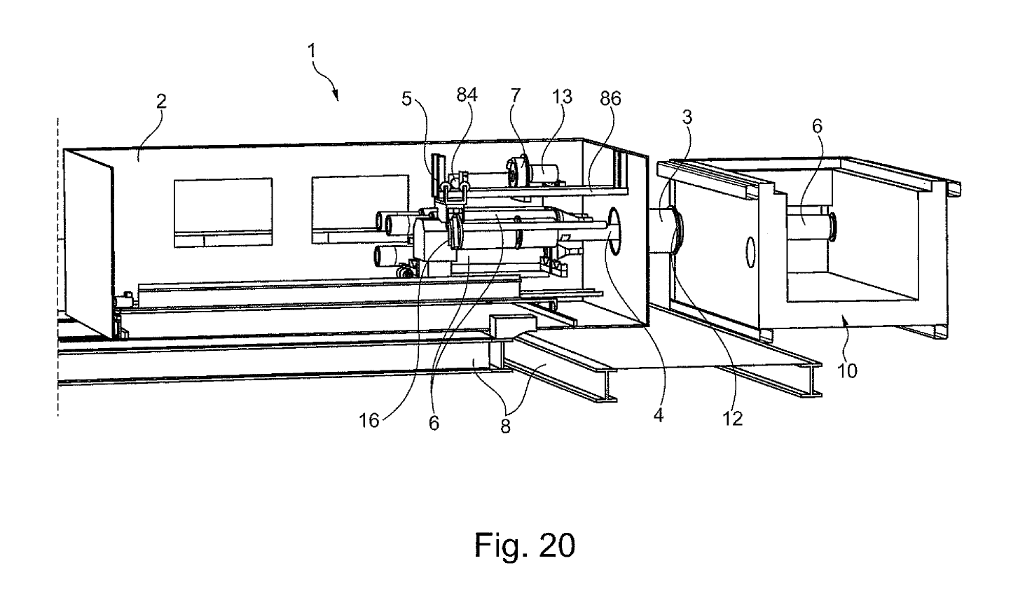

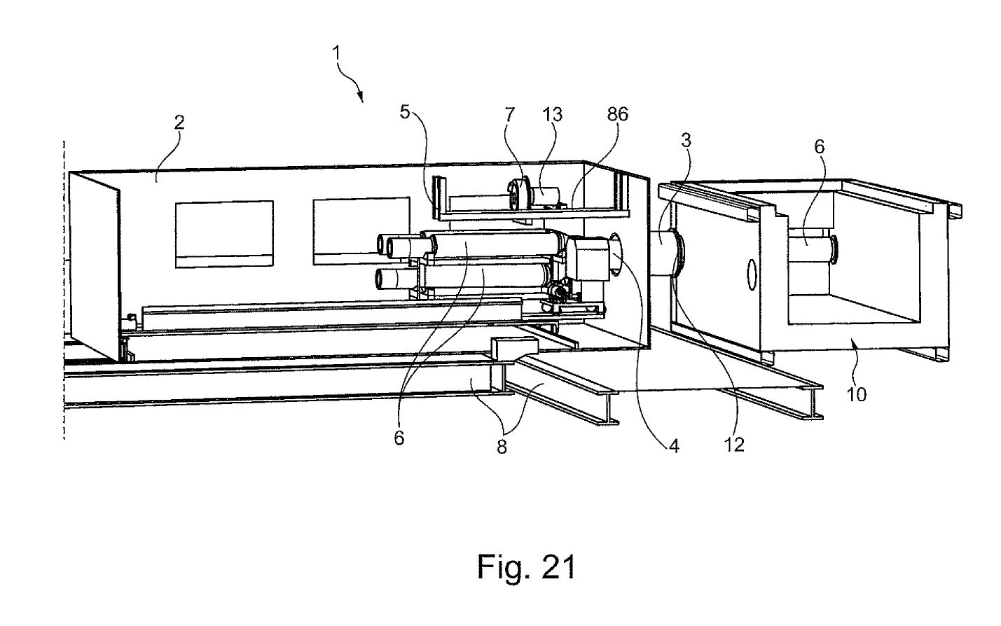

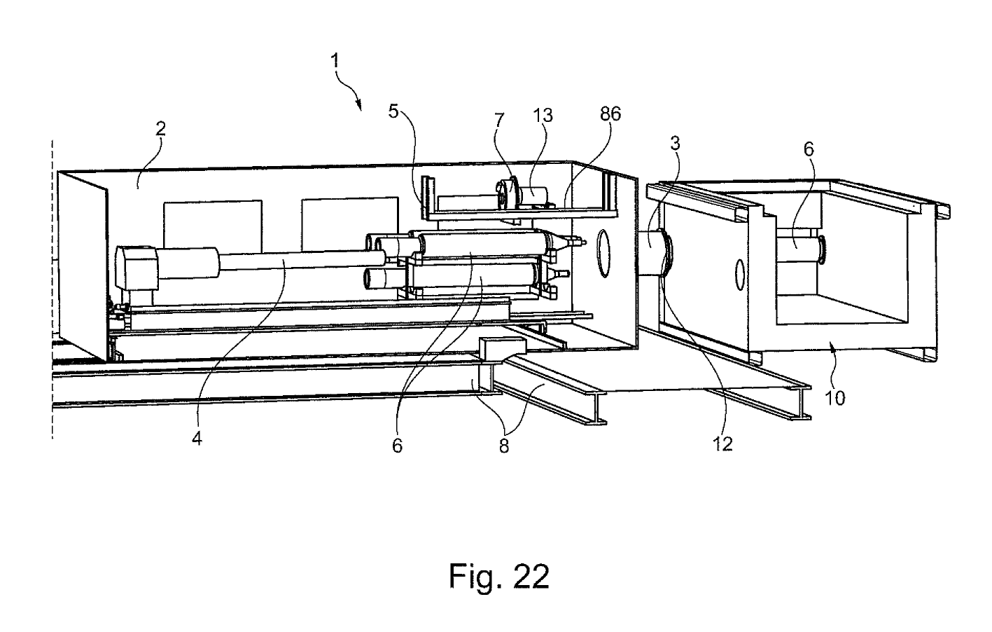

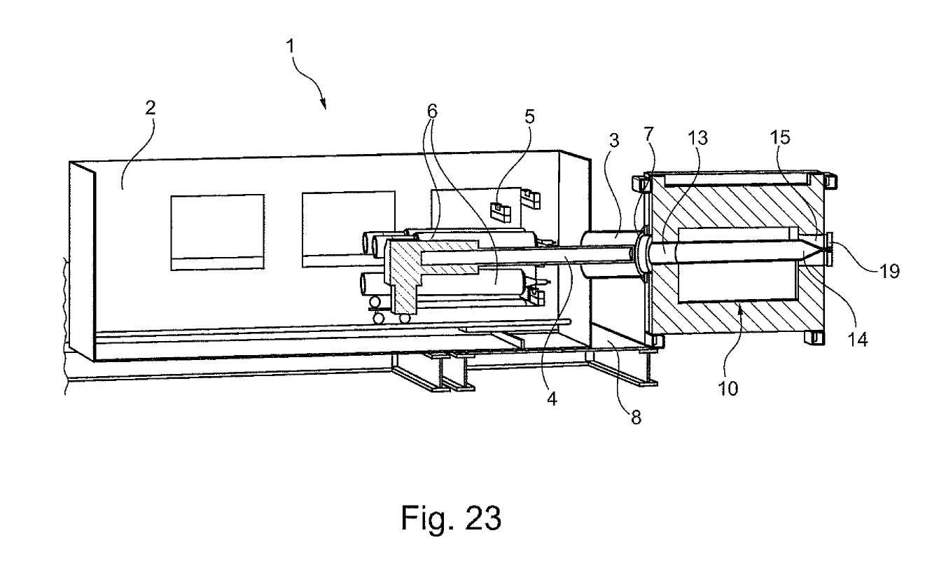

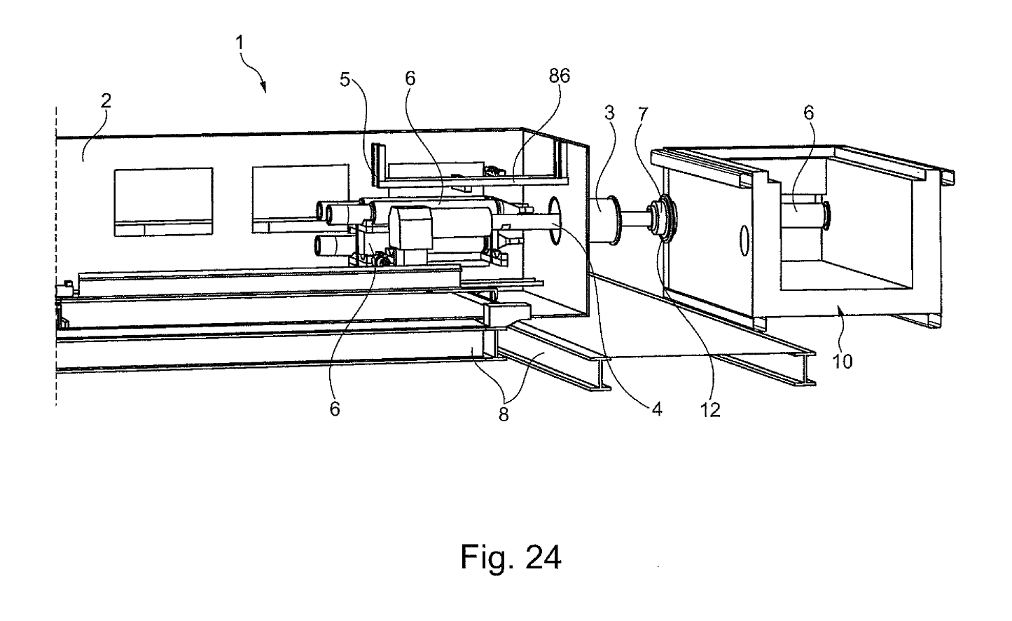

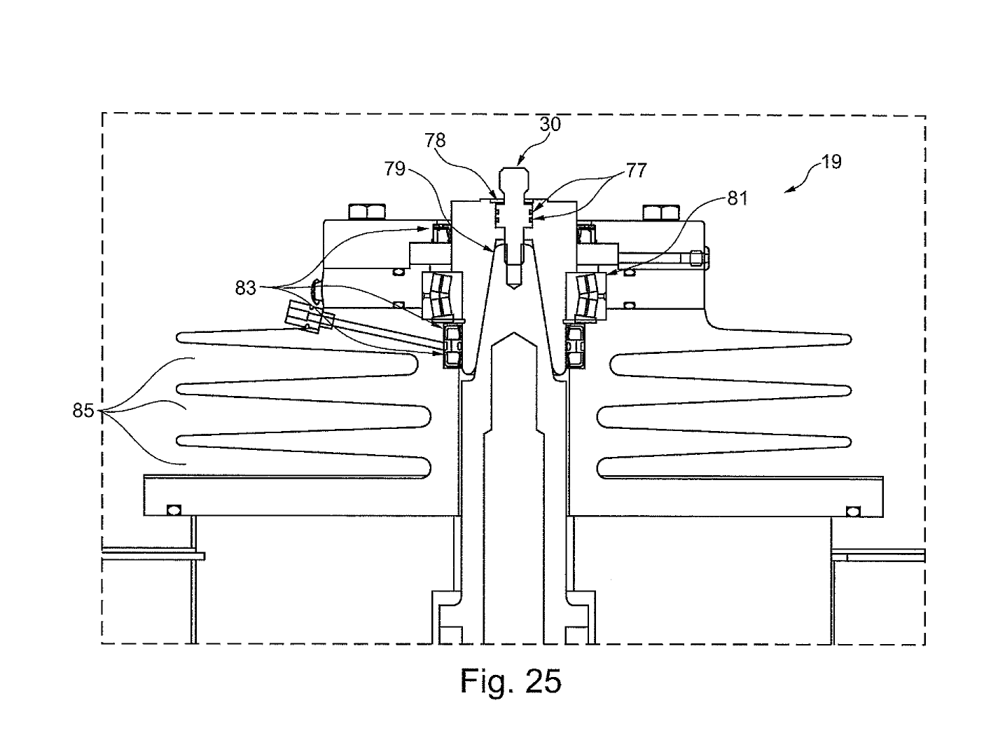

The roller changing apparatus 1 is positioned in the corresponding exchange position along a longitudinal furnace axis 9 with the aid of a platform 8 and moved toward the furnace 10 (FIG. 2 to FIG. 4). The various connections on the furnace 10 are closed. The lance 4 is moved out from the housing 2 and presses against the sealing cap 7 of the roller 6 in order to preserve a tight seal, then the cap screws can be removed (FIG. 5). Subsequently, the fitting 3 moves completely against a furnace flange 12 over the cap 7. The pressure exerted upon the cap is still maintained by means of path compensation and pneumatic force compensation. The flange connection is produced with screws (FIG. 6). The housing 2 is flushed with nitrogen (N₂). The lance 4 pulls out the cap 7 including an isolation plug 13 by means of a catch and deposits the cap on a shelf 5 (FIG. 7 and FIG. 8). Subsequently, the lance 4 moves into the internally hollow roller 6 (FIG. 9) and forces off the movable bearing 15 at the rearmost end by means of a pneumatic catch (FIG. 10). The roller 6 is now supported by the lance 4. In order to create space for a strip support shell 26, the lance 4 is extended to the extreme support position and the strip support shell 26 is subsequently positioned (FIG. 11), is moved into the furnace 10 and is subsequently pivoted in order to support the strip situated in the furnace 10 (FIG. 12). An anchoring device in the lance 4 fixes the roller 6 at the lance 4. The roller drive 17 on the outside of the furnace is now decoupled on the opposite furnace side (FIG. 13) and the gas-tight fixing screw 30 of the fixed bearing 19 is removed (FIG. 14 and FIG. 25). The roller 6 is moved out of the furnace 10 and deposited on the shelf 5 (FIG. 15 to FIG. 17). A new roller 6 is picked up, is moved into the furnace 10 and is fixed at the fixed bearing 19 (FIG. 18). The lance 4 once again moves to the extreme support position in order to create space for removing the strip support shell 26 (FIG. 19, FIG. 20). The lance 4 now moves completely into the furnace 10 in order to position the movable bearing 15 (FIG. 21). Subsequently, the cap 7 can be retrieved from its storage position (FIG. 22), reinserted and pressed on (FIG. 23). The furnace 10 is now once again tight and the flange screws can be tightened again. The housing 2 is moved back by a certain distance, but the cap 7 is still pressed on (FIG. 24). The cap screws are tightened and the housing 2 is moved back on the platform 8. The connections can be once again reconnected to the furnace 10. The process of exchanging the hearth roller is completed.

This procedure is once again described in greater detail below:

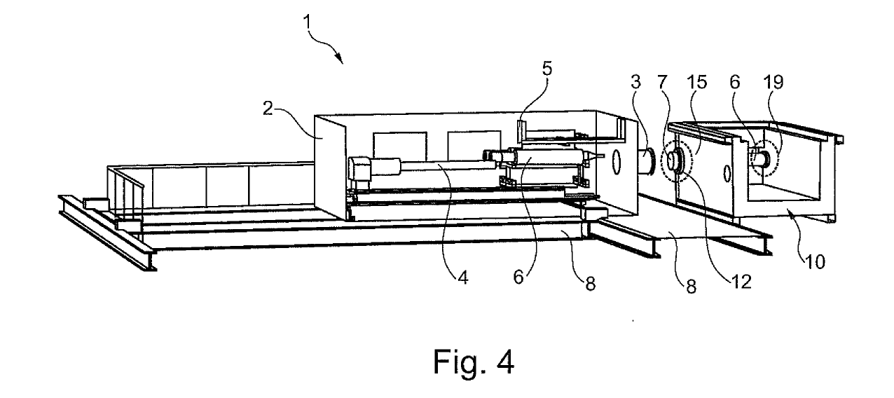

FIG. 4 shows how the roller changing apparatus 1 is positioned relative to the roller 6 to be exchanged in the furnace 10. This takes place by correspondingly moving the platform 8 to the nominal position.

FIG. 5 shows how the lance 4 of the roll changing apparatus 1 is moved out from the housing 2 through a lock in a wall of the housing 2 in order to handle the roller 6 to be exchanged in the furnace 10.

For this purpose, the lock at the wall of the housing 2 comprises the attachment fitting 3 at the outside of the housing that can be attached to the furnace 10 in a sealing fashion—while enclosing or accommodating a cap 7 of the roller 6 to be exchanged at the outside of the furnace. The latter is illustrated in FIG. 6, in which the attachment fitting 3 is screwed to the corresponding flange 12 of the furnace 10 in a gas-tight fashion. In this state, a fluidic connection between the interior of the housing 2 and the interior of the furnace 10 is not yet produced because the cap 7 of the roller 6 is still installed at the furnace 10. For example, the housing 2 may be flushed with nitrogen in this state.

FIG. 7 shows the arbor of the lance 4 as it is pressed against the cap 7 of the roller 6. The arbor may be water-cooled. The actual roller 6 is illustrated in the form of a hollow cylindrical component 80 between an isolation plug 13 and an outer wall 82 in FIG. 7.

FIG. 8 shows the arrangement in a state, in which the cap 7 including the isolation plug 13 was transferred from the interior of the furnace 10 into the interior of the housing 2 in a gas-tight fashion through art internal lumen of the docking fitting 3 and deposited on a shelf 5 (for example in a robot-controlled fashion). The catch of the lance 4 has forced this cap 7 off the furnace 10 and transferred the cap into the interior of the housing 2. A pneumatic spreader 90 that is illustrated in the form of annular circumferential slots at the arbor 4 in FIG. 8 and at a later point in time engages at the roller 6 from the inside in order to move this roller out of the furnace 10 is already mentioned at this point. For this purpose, anchoring structures can be extended through the annular circumferential slots.

FIG. 9 shows how the lance 4 is slightly tilted in order to raise the roller 6. In this way, a load alleviation of the roller 6 can take place at the movable bearing 15, on which the roller 6 was previously supported. This prepares the subsequent removal of the outer plug. A drive unit 17 of the roller 6 that is positioned outside the furnace 10 and acts upon the side of the fixed bearing 19 is schematically illustrated in FIG. 9. A conical end section 74 of the roller 6 is embedded in a corresponding counterpart of the fixed bearing 19.

FIG. 10 shows how the outer wall 82 of the roller 6 including the movable bearing 15 is removed after the roller 6 was raised by raising the roller 6 with the aid of the lance 4 and therefore was alleviated relative to the movable bearing 15.

FIG. 11 shows how the shell 26 illustrated in the form of a bent sheet metal with water cooling (for example a segment amounting to a fourth or a sixth of a pipe) is handled. The strip support shell 26 can be displaced in a translative fashion and rotated by means of a traveling trolley 84 that can move along a guide 86 and by means of a pivoting element 16. The strip support shell 26 encompasses the arbor of the lance 4 at the outer side.

FIG. 12 shows how the rotary device 16 is pivoted once the strip support 26 was moved into the interior of the furnace 10. In order to be descriptive, the shell 26 is pivoted upward from an underside of the roller 6 (not illustrated in FIG. 12) by means of the rotary device 16. In this way, the underside of a component to be thermally treated in the form of a strip that is also not illustrated in FIG. 12 can be supported by the strip support shell 26 realized in the form of a pipe section. This allows a subsequent removal of the roller without having to remove the strip from the furnace 10.

FIG. 13 shows a driveshaft 17 for driving the corresponding roller 6. FIG. 13 also shows an outer wall of the furnace 10 with a fixed bearing 19 arranged thereon. In order to remove the driveshaft 17, screws can be unscrewed—in a manual or machine-controlled fashion—as indicated with the reference symbol 66.

FIG. 14 shows an enlarged illustration of the roller 6 in the region of the fixed bearing 19. The roller 6 can be forced off by means of a gas-tight screw 30. A lateral locking element 18 is furthermore shown.

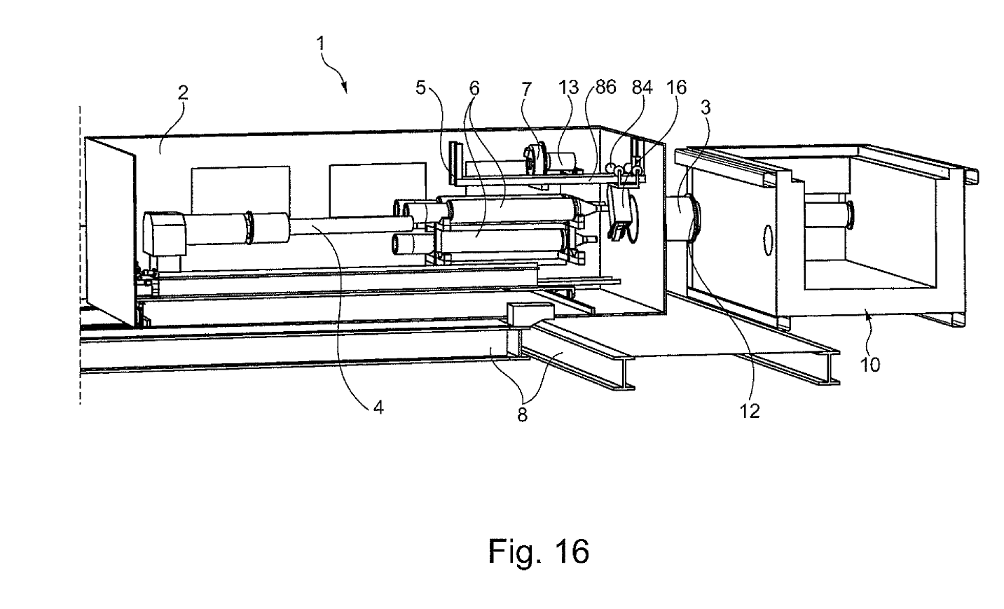

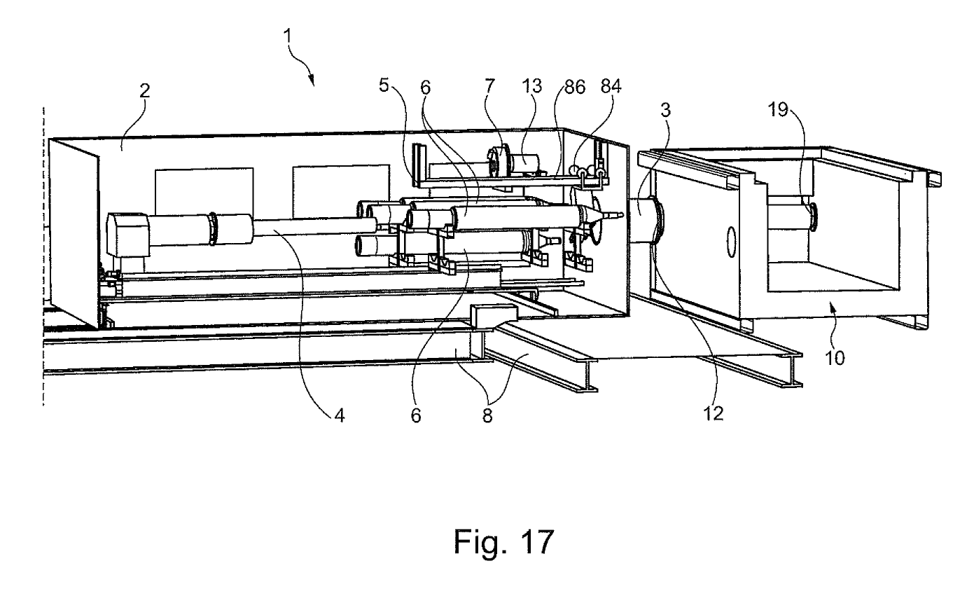

FIG. 15 shows how the roller 6 is picked up after it was also released on the fixed bearing side. The roller 6 is fixed at the lance 4 with the spreader 90 illustrated in FIG. 8 and the roller 6 is subsequently moved from the furnace 10 into the housing 2 and stored on the shelf 5. FIG. 16 and FIG. 17 show how the roller 6 is arranged in the housing 2.

The installation of a new roller 6 into the furnace 10 begins with FIG. 18. In this case, the fixed bearing 19 initially needs to be installed at the new roller 6 before the strip support 26 is handled in accordance with FIG. 19 and FIG. 20.

FIG. 21 shows how the movable bearing 15 is subsequently installed. The cap 7 is then retrieved in accordance with FIG. 22 and the cap 7 is positioned and pressed on in accordance with FIG. 23 before the housing 2 is detached from the furnace 10 and the cap 7 is secured with screws (FIG. 24).

FIG. 25 once again shows the fixed bearing 19 in greater detail. Two O-rings 77, that improve the seal, are provided on the screw 30. Furthermore, a locking ring 78 is provided that makes it possible to press out the roller 6. A conical seat is identified by the reference symbol 79. A spherical roller bearing 81 is also shown. In addition, shaft ring seals 83 are illustrated in this figure. Cooling ribs 85 are also shown.

As a supplement, it should be noted that “comprising” does not exclude any other elements or steps, and that “a” or “an” does not exclude a plurality. It should furthermore be noted that features or steps that were described with reference to one of the above exemplary embodiments can also be used in combination with other characteristics or steps of other above-described exemplary embodiments. Reference symbols in the claims should not be interpreted in a restrictive sense.

1-22. (canceled)

23. A roller changing apparatus for changing one roller of a multitude of rollers of a furnace for a thermal treatment of components, wherein the roller changing apparatus comprises:
a housing that can be sealed and in which a first protective gas atmosphere can be formed;
a roller handling device that is at least partially arranged in the housing and designed for removing the roller to be exchanged from the furnace and for installing a replacement roller at the furnace while essentially maintaining a high temperature and a second protective gas atmosphere in the furnace during the roller exchange.

24. The roller changing apparatus as set forth in claim 23, comprising
a platform that is designed for moving the roller handling device including the housing relative to the furnace in order to position the roller handling device relative to the roller to be exchanged.

25. The roller changing apparatus as set forth in claim 23, wherein
the roller handling device is movable at least partially out from the housing through a lock in a wall of the housing in order to handle the roller to be exchanged.

26. The roller changing apparatus as set forth in claim 25, wherein
the lock in the wall of the housing comprises at the outside of the housing an attachment fitting that is designed for being attached to the furnace in such a way that a tight connection, in particular a connection that is gas-tight relative to the surroundings, can be produced between an interior of the housing and an interior of the furnace.

27. The roller changing apparatus as set forth in claim 23, wherein
the roller handling device is designed in such a manner that it is movable in a translative fashion along one, two or three dimensions and/or designed in a pivotable fashion.

28. The roller changing apparatus as set forth in claim 23, wherein
the roller handling device is designed for exerting a closing pressure that seals the furnace upon a cap while at least one fastening element is removed from the cap of the roller to be exchanged in a manual or machine-controlled fashion in order to separate the cap from the furnace.

29. The roller changing apparatus as set forth in claim 23, wherein
the roller handling device is designed for removing a cap of the roller to be exchanged from the furnace, in particular by means of a catch.

30. The roller changing apparatus as set forth in claim 29, wherein
the roller handling device is designed for transporting the removed cap into the interior of the housing and for storing the cap therein.

31. The roller changing apparatus as set forth in claim 26, wherein
the roller handling device is designed for removing the cap of the roller to be exchanged from the furnace and for transporting the cap into the housing through the attachment fitting mounted on the furnace.

32. The roller changing apparatus as set forth in claim 23, wherein
the roller handling device is designed for moving into a cavity of the roller to be exchanged in the furnace and for raising the roller to be exchanged relative to a movable bearing in the furnace.

33. The roller changing apparatus as set forth in claim 32, wherein
the roller handling device is designed for transporting the movable bearing into the interior of the housing and for storing the movable bearing therein, in particular by means of a catch, after moving into the cavity of the roller to be exchanged.

34. The roller changing apparatus as set forth in claim 23, comprising
a component support mechanism, in particular at least partially arranged in the interior of the housing, for supporting one of the components in the furnace during at least part of the exchange of the roller.

35. The roller changing apparatus as set forth in claim 34, wherein
the component support mechanism is movable in a translative fashion and/or pivotable relative to the housing.

36. The roller changing apparatus as set forth in claim 34, wherein
the component support mechanism comprises a pipe segment that can be moved into the furnace and that is pivotable around the roller to be exchanged in order to thusly support one of the components.

37. The roller changing apparatus as set forth in claim 23, wherein
the first protective gas atmosphere and the second protective gas atmosphere are free of oxygen, and wherein in particular the first protective gas atmosphere is an inert gas atmosphere, in particular a nitrogen atmosphere, and wherein the second protective gas atmosphere is a burnable gas atmosphere, in particular a hydrogen atmosphere.

38. An arrangement featuring:
a roller changing apparatus as set forth in claim 23;
the furnace for the thermal treatment of components.

39. A method for changing a roller of a multitude of rollers of a furnace for the thermal treatment of components, wherein the method comprises:
forming a first protective gas atmosphere in a sealable housing of a roller changing apparatus;
removing the roller to be exchanged from the furnace with a roller handling device of the roller changing apparatus that is at least partially arranged in the housing;
installing a replacement roller on the furnace with the roller handling device;
wherein a high temperature and a second protective gas atmosphere are essentially maintained in the furnace during the removal and during the installation.

40. The method as set forth in claim 39, wherein
a high temperature that lies in the range between 500° C. and 1200° C. is maintained in the furnace during the exchange of the roller.

41. The method as set forth in claim 39, wherein
during the exchange of the roller an interior of the furnace remains sealed relative to the surroundings of the furnace and relative to the surroundings of the roller changing apparatus, in particular remains fluidically connected only to an interior of the roller changing apparatus, and furthermore remains, in particular, free of oxygen.

42. The method as set forth in one of claim 39, wherein
prior to the removal of the roller from the furnace a drive unit is detached from a fixed bearing side of the furnace and the roller to be exchanged is forced off by means of a gas-tight screw.
